(19) United States
(12) Patent Application Publication
(10) Pub. No.: US 2015/0121685 A1
(43) Pub. Date: May 7, 2015

(54) COUPLED SPOT-SIZE-CONVERTER ARRAYS FOR WAFER-LEVEL OPTICAL METROLOGY

(71) Applicant: HGST NETHERLANDS B.V., Amesterdam (NL)

(72) Inventors: Thomas William CLINTON, Danville, CA (US); Juraj TOPOLANCIK, San Jose, CA (US)

(73) Assignee: HGST NETHERLANDS B.V., Amsterdam (NL)

(21) Appl. No.: 14/071,424

(22) Filed: Nov. 4, 2013

(51) Int. Cl. G01N 21/84; G11B 5/31; G11B 5/48; G01N 21/47

(52) U.S. Cl. CPC G01N 21/84; G01N 21/47; G11B 5/3166; G11B 5/4866
USPC 29/593; 356/432

(57) ABSTRACT

Embodiments of the present invention generally relate to an optical metrology system and methods of using the optical metrology system. The optical metrology system has a linear optical array including a plurality of optical components. One end of the linear optical array is configured to receive a confined beam. At various stages of the fabrication process, the performance of the actual optical components used in HAMR devices is evaluated based on the performance of the optical metrology system.

### BACKGROUND

1. Field

Embodiments of the present invention generally relate to data storage systems, and more particularly, to fabrication of heat-assisted magnetic recording (HAMR) heads.

2. Description of the Related Art

Higher storage bit densities in magnetic media used in disk drives have reduced the size (volume) of magnetic bits to the point where the magnetic bit dimensions are limited by the grain size of the magnetic material. Although grain size can be reduced further, the data stored within the cells may not be thermally stable. That is, random thermal fluctuations at ambient temperatures may be sufficient to erase data. This state is described as the superparamagnetic limit, which determines the maximum theoretical storage density for a given magnetic media. This limit may be raised by increasing the coercivity of the magnetic media or by lowering the temperature. Lowering the temperature may not always be practical when designing hard disk drives for commercial and consumer use. Raising the coercivity, on the other hand, requires write heads that incorporate higher magnetic moment materials, or techniques such as perpendicular recording (or both).

One additional solution has been proposed, which uses heat to lower the effective coercivity of a localized region on the magnetic media surface and writes data within this heated region. The data state becomes “fixed” once the media cools to ambient temperatures. This technique is broadly referred to as “thermally assisted (magnetic) recording” (TAR or TAMR), “energy assisted magnetic recording” (EAMR), or “heat-assisted magnetic recording” (HAMR) which are used interchangeably herein. It can be applied to longitudinal and perpendicular recording systems as well as “bit patterned media”. Heating of the media surface has been accomplished by a number of techniques such as focused laser beams or near-field optical sources.

Fabrication of HAMR heads involves a series of fabrication steps inserted into the standard magnetic-recording head-build process flow to define two optical components: a microphotonic spot-size converter (SSC) and a near-field transducer (NFT). SSC converts a highly-divergent output of an external semiconductor laser diode into a well-confined mode that couples into the NFT. The NFT is a plasmonic nano-antenna that further focuses the light into an ultra-small spot-size for high-density magnetic recording. Due to the complexity of the fabrication process and a lack of reliable optical metrology, it remains challenging to evaluate the effect of individual fabrication steps on the efficiency of the HAMR optical delivery system and to optimize the steps accordingly to improve performance. Therefore, there is a need in the art for an improved optical metrology component for HAMR heads.

### SUMMARY OF THE INVENTION

Embodiments of the present invention generally relate to an optical metrology system and methods of using the optical metrology system. The optical metrology system has a linear optical array including a plurality of optical components. One end of the linear optical array is configured to receive a confined beam. At various stages of the fabrication process, the performance of the actual optical components used in HAMR devices is evaluated based on the performance of the optical metrology system.

In one embodiment, a method for evaluating performance of optical components of a heat assisted magnetic recording device is disclosed. The method includes depositing an optical metrology system on a wafer. The optical metrology system includes a grating and a linear optical array of SSCs. The linear optical array has a bottom cladding, a waveguide disposed over the bottom cladding, and a top cladding disposed over the bottom cladding and the waveguide. The method further includes coupling a probing light using the grating into the linear optical array, measuring an optical output from the linear optical array and determining an optical loss parameter.

In another embodiment, an optical metrology system is disclosed. The optical metrology system includes a first grating disposed at a first end of the optical metrology system and a linear optical array. The linear optical array includes a bottom cladding, a waveguide disposed over the bottom cladding and a top cladding disposed over the bottom cladding and the waveguide.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1B illustrate a disk drive system, according to embodiments described herein.

FIG. 2 illustrates a spot-size converter according to one embodiment described herein.

FIG. 3 illustrates a linear optical array of spot-size converters according to embodiments described herein.

FIG. 4 is a chart showing a relationship between normalized transmitted intensity and number of spot-size converters in the linear optical array, according to embodiments described herein.

FIG. 5 is a chart showing a relationship between log of intensity and number of spot-size converters in the linear optical array, according to embodiments described herein.

FIGS. 6A-6D illustrate a process of forming the spot-size converter according to embodiments described herein.

FIGS. 7A-7D illustrate a process of forming an optical metrology system according to embodiments described herein.

FIG. 8 is a chart showing the relationship between sin (0) and the grating period, according to embodiments described herein.

FIGS. 9A-9B show a multiple waveguide design according to embodiments described herein.

FIGS. 10A-10B show a method of measuring intensity of light according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Embodiments of the present invention generally relate to an optical metrology system and methods of using the optical metrology system. The optical metrology system has a linear optical array including a plurality of optical components. One end of the linear optical array is configured to receive a confined beam. At various stages of the fabrication process, the performance of the actual optical components used in HAMR devices is evaluated based on the performance of the optical metrology system.

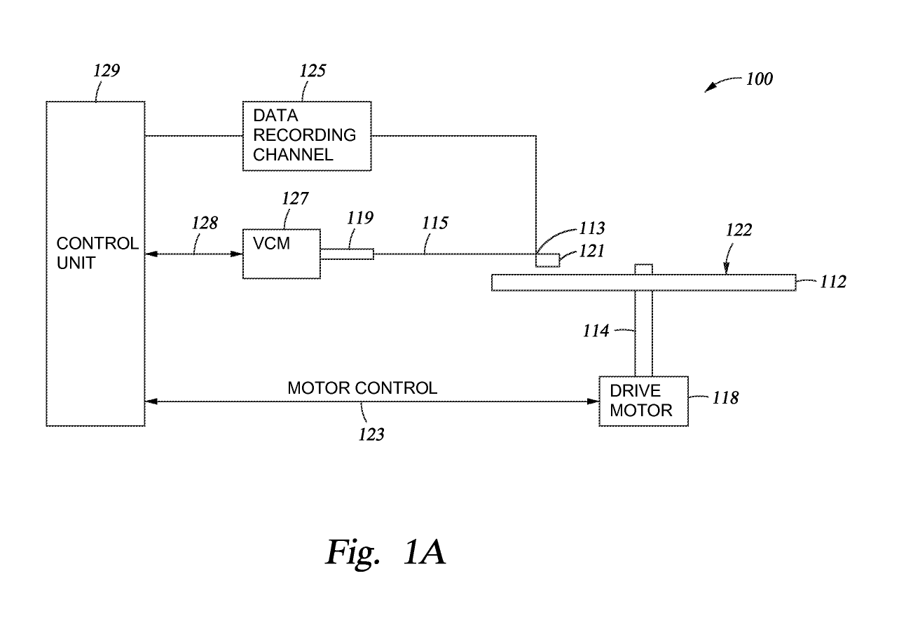

FIG. 1A illustrates a disk drive 100 embodying this invention. As shown, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121 that may include a radiation source (e.g., a laser or electrically resistive heater) for heating the disk surface 122. As the magnetic disk rotates, the slider 113 moves radially in and out over the disk surface 122 so that the magnetic head assembly 121 may access different tracks of the magnetic disk 112 where desired data are written. Each slider 113 is attached to an actuator arm 119 by way of a suspension 115. The suspension 115 provides a slight spring force which biases the slider 113 against the disk surface 122. Each actuator arm 119 is attached to an actuator means 127. The actuator means 127 as shown in FIG. 1A may be a voice coil motor (VCM). The VCM comprises a coil movable within a fixed magnetic field, the direction and speed of the coil movements being controlled by the motor current signals supplied by control unit 129.

During operation of a TAR or HAMR enabled disk drive 100, the rotation of the magnetic disk 112 generates an air bearing between the slider 113 and the disk surface 122 which exerts an upward force or lift on the slider 113. The air bearing thus counter-balances the slight spring force of suspension 115 and supports slider 113 off and slightly above the disk 112 surface by a small, substantially constant spacing during normal operation. The radiation source heats up the high-coercivity media so that the write elements of the magnetic head assemblies 121 may correctly magnetize the data bits in the media.

The various components of the disk drive 100 are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads on the assembly 121 by way of recording channel 125.

The above description of a typical magnetic disk storage system and the accompanying illustration of FIG. 1A are for representation purposes only. It should be apparent that disk storage systems may contain a large number of disks and actuators, and each actuator may support a number of sliders.

FIG. 1B is a cross sectional schematic of a TAR enabled write head 101, according to one embodiment described herein. The head 101 is operatively attached to a laser 155 (i.e., a radiation source) that is powered by a laser driver 150. The laser 155 may be placed directly on the head 101 or radiation may be delivered from a laser 155 located separate from the slider through an optical fiber or waveguide. Similarly, the laser driver 150 circuitry may be located on the slider 113 or on a system-on-chip (SOC) associated with the disk drive 100 such as the control unit 129 as shown in FIG. 1A. The head 101 includes a SSC 130 for focusing the radiation transmitted by the laser 155 into the waveguide 135. In some embodiments, the waveguide 135 is part of the SSC 130, meaning the SSC 130 also functions as a waveguide. In another embodiment, the head 101 may include one or more lens for focusing the beamspot of the laser 155 before the emitted radiation reaches the spot-size converter 130. The waveguide 135 is a channel that transmits the radiation through the height of the head 101 to the optical transducer 140—e.g., a plasmonic device—which is located at or near the air-bearing surface (ABS). The optical transducer 140 further focuses the beamspot to avoid heating neighboring tracks of data on the disk 112—i.e., creates a beamspot much smaller than the diffraction limit. As shown by arrows 142, this optical energy emits from the optical transducer 140 to the surface of the disk 112 below the ABS of the head 101. The embodiments herein, however, are not limited to any particular type of radiation source or technique for transferring the energy emitted from the radiation source to the ABS.

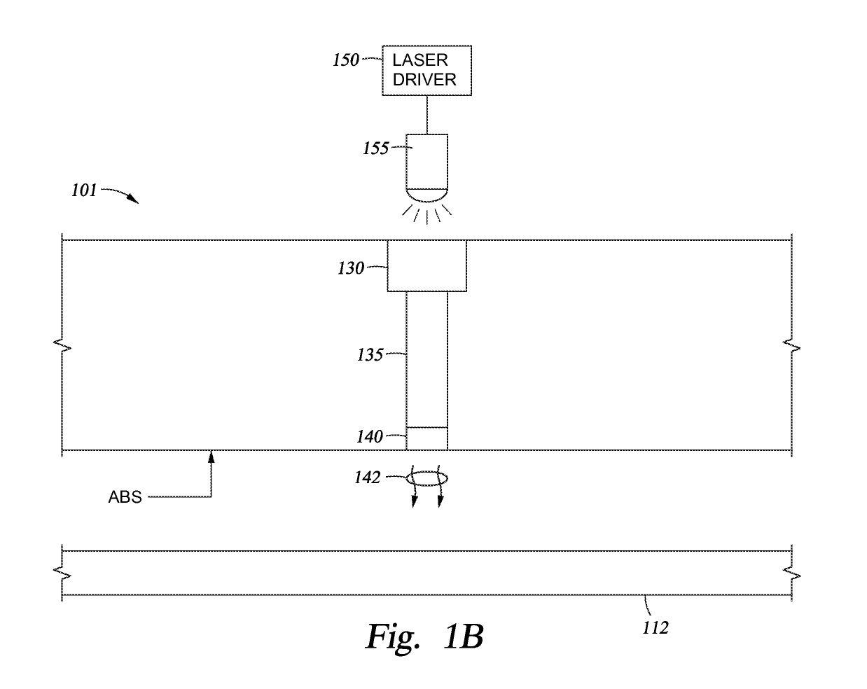

FIG. 2 illustrates the SSC 130 according to one embodiment of the invention. The SSC 130 has a core 202 surrounded by cladding material 204. The core 202 is made of tantalum pentoxide and the cladding material 204 is alumina. The index contrast between the core 202 and the cladding material 204 is about 0.5 RIUs. The core 202 has a straight section 206 and a tapered section 208. The straight section 206 has a length “D1” of about 10 micrometers and the tapered section 208 has a length “D2” of about 100 micrometers. During operation, a highly divergent beam having a large spot size, as shown in 212, is converted by the SSC 130 to form a tightly focused beam having a smaller spot size, as shown in 210. The highly divergent beam may come from the laser 155 and then passes through the SSC 130 from the tapered section 208 to the straight section 206. At the tapered section 208, the divergent beam has large spot size. At the straight section 206, the confined beam has a small spot size.

A plurality of SSCs 130 is formed on a plurality of sliders 113 that are formed on a wafer. Each slider 113 is then separated from the wafer, and then the performance of the SSC 130 disposed on the slider 113 is tested. It would be beneficial to be able to test the performance of the SSCs 130 when they are still disposed on the wafer, i.e., on the wafer level.

Traditional optical metrology tools for characterization of miniaturized optical components such as SSCs used in HAMR perform the analysis by measuring the intensity of light coupled into the device (Iᵢₙ) and the light emitted from the device (Iₒᵤₜ) to determine the optical loss coefficient (α). The conventional definition of decibel based on base-10 logarithm is chosen to express the magnitude of the loss coefficient in dBs, i.e. α[dB]=10*log₁₀(I_{out/}Iᵢₙ). The optical loss coefficient includes the intrinsic loss parameter (αᵢₙₜ) related to the device design and material parameters and the extrinsic loss parameter (αₑₓₜ) resulting from fabrication-induced imperfection such as surface roughness and dimensional variations. The αᵢₙₜ can be determined with electromagnetic modeling tools. The extrinsic losses need to be minimized and monitored during the fabrication process because the extrinsic losses degrade the HAMR device performance beyond what is predicted by simulations. The relationship between the measured optical intensities and the relevant loss parameters is given by: Iₒᵤₜ=Iᵢₙ*10^{(αin+αout+αint+αext)/10}, where αᵢₙ and αₒᵤₜ are the in and out coupling loss parameters, respectively. The αₑₓₜ should be kept within a specified range in order to guide process optimization aimed at reducing the magnitude and the variance across wafer of the extrinsic loss. The magnitude of αₑₓₜ can be quite difficult to extract from measurements of: Iᵢₙ and Iₒᵤₜ because of the uncertainty in magnitude of the coupling loss parameters αᵢₙ and αₒᵤₜ. Coupling loss with a large variance would inevitably obscure the measurement of αₑₓₜ.

In addition, the problem of evaluating αₑₓₜ on an intact wafer is considerably more difficult because such characterization requires high-precision fabrication of miniaturized optical components (typically waveguide gratings, V-grooves, wedge (prism) couplers, or evanescent couplers) for efficient coupling of light into the wafer plane. Fabricating high-quality optical couplers with small variances in αᵢₙ and αₒᵤₜ is just as challenging as making an efficient SSC. The magnitude of αᵢₙ depends on the profile of the probing beam incident upon the SSC input which is difficult to control on wafer level. Reliable measurements of αₑₓₜ to characterize SSC performance is not possible if the efficiencies of the coupling components vary considerably across the wafer.

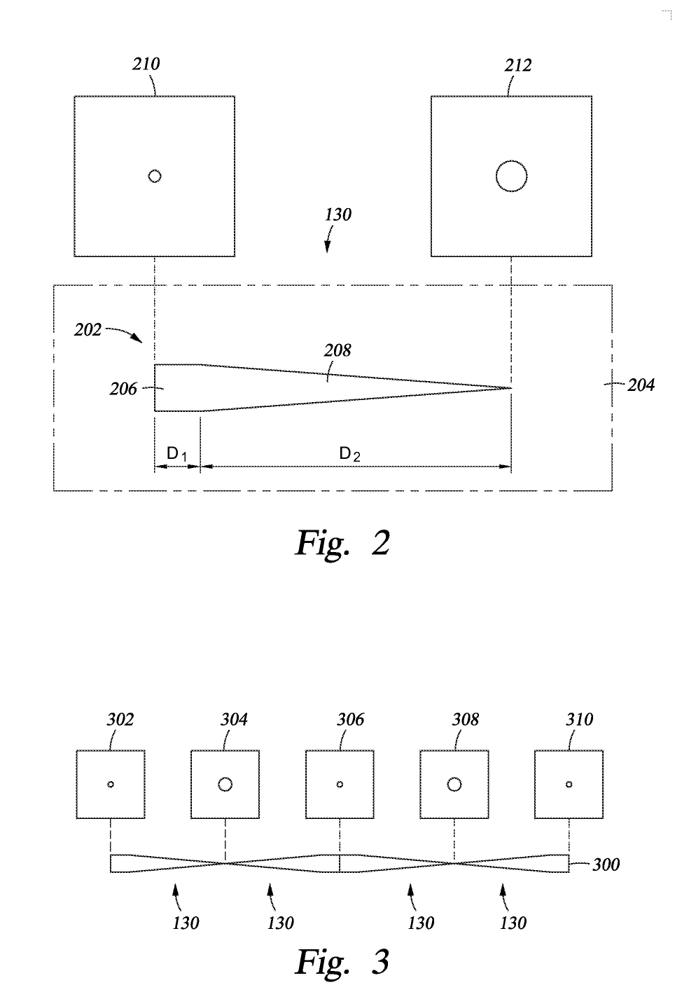

FIG. 3 illustrates a linear optical array 300 of SSCs 130 according to one embodiment of the invention. The linear optical array 300 is part of an optical metrology system deposited on a wafer in addition to the actual light delivery components, such as SSC 130, used in HAMR devices. The optical metrology system may include grating couplers (discussed in detail below) in addition to the linear optical array 300, and the optical metrology system is straightforward to fabricate with minimal modifications of the standard HAMR head-build process. Any fabrication-induced structural imperfections introduced into the optical delivery system will be also imparted on the metrology components.

For a single SSC 130, the conversion of the highly divergent beam into a confined beam performed by the SSC 130 has some characteristic loss α, where α=αᵢₙₜ+αₑₓₜ. The associated decrease in optical intensity (total intensity integrated over the whole spot-size) due to the transformation from the highly divergent beam to the confined beam is proportional to 10^{α/10}. In particular, Iₒᵤₜ=Iᵢₙ*10^{α/10}. The same SSC 130 operated in reverse direction will convert a confined beam into a highly divergent beam with the same efficiency, i.e., Iₒᵤₜ=Iᵢₙ*10^{β/}10, where β is the characteristic loss of conversion of the confined beam into the highly divergent beam. Since the Maxwell equations are time-reversible and there are no photons created and lost during the conversion process, α=β.

As shown in FIG. 3, a plurality of SSCs 130 forms the linear optical array 300. Other optical components such as cavities, beam-shapers, collimators or add-drop filters may be used to form the linear optical array 300. The cores of the SSCs 130 are connected in a way that the straight section of the core of a SSC is connected to the straight section of the core of an adjacent SSC and the tapered section of the core of the SSC is connected to the tapered section of the core of another adjacent SSC. The linear array 300 has one end that is the straight section of the core of a SSC. Thus, the linear array 300 performs the following conversion: a confined beam (302) is first converted into a divergent beam (304) that is similar to the one produced by the laser 155, which is then converted back into the original confined beam (306). The conversion may be repeated several times (308, 310) depending on the number of the SSCs 130 in the linear optical array 300. The confined beam enters the linear optical array 300 from the end having the straight section of the SSC since the confined beam contains less stray-light background. As a result, using a confined beam passing through the linear optical array 300 from the end having the straight section provides better control over the profile of the incident and outgoing beams.

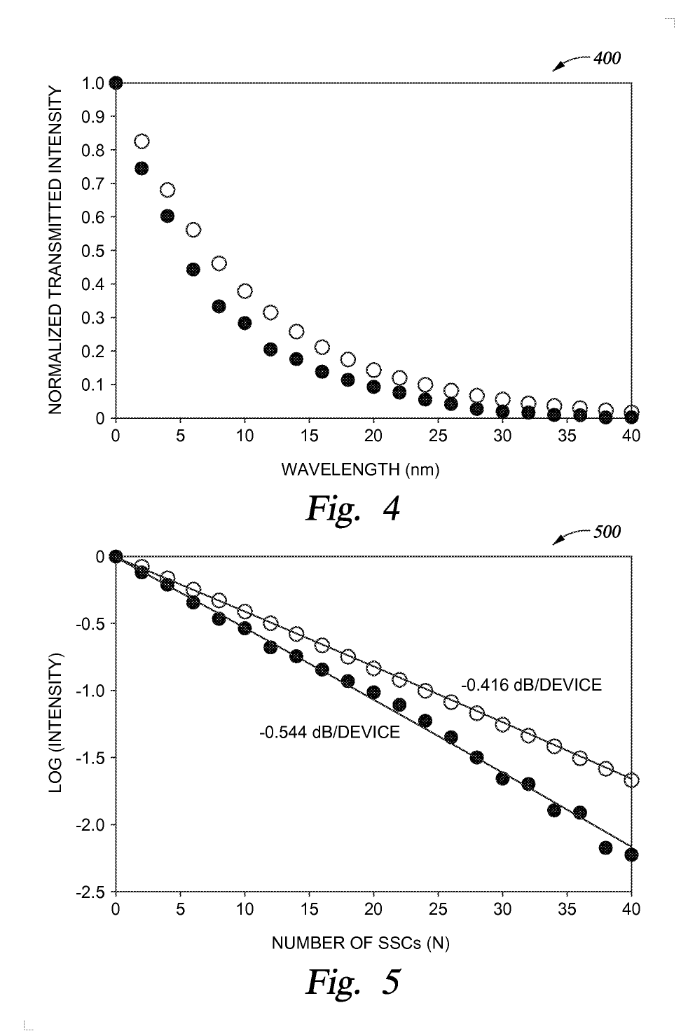

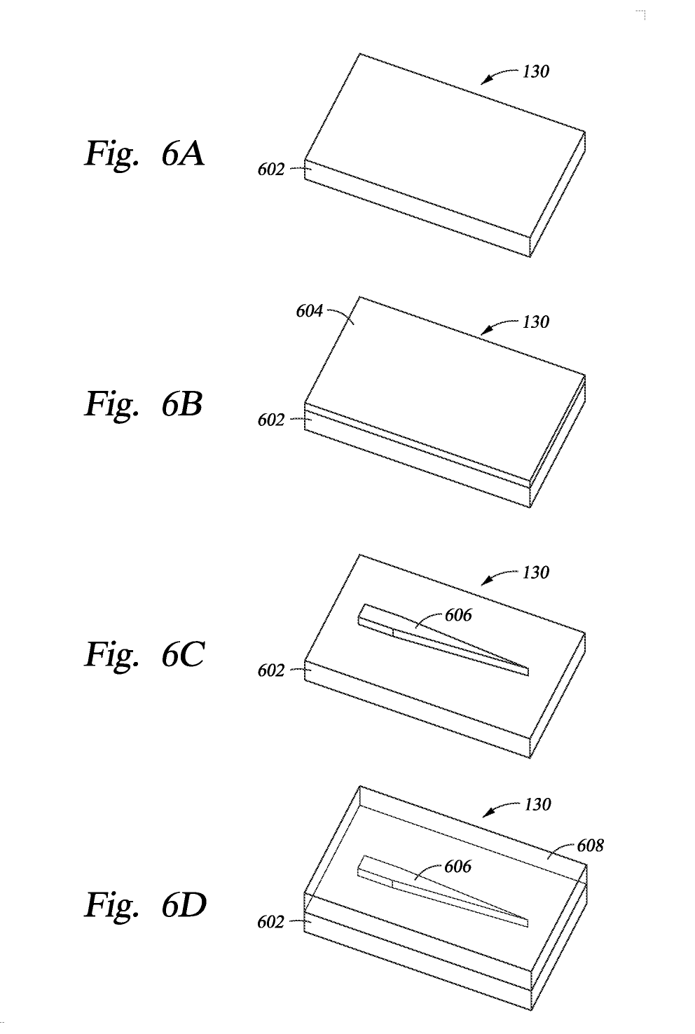

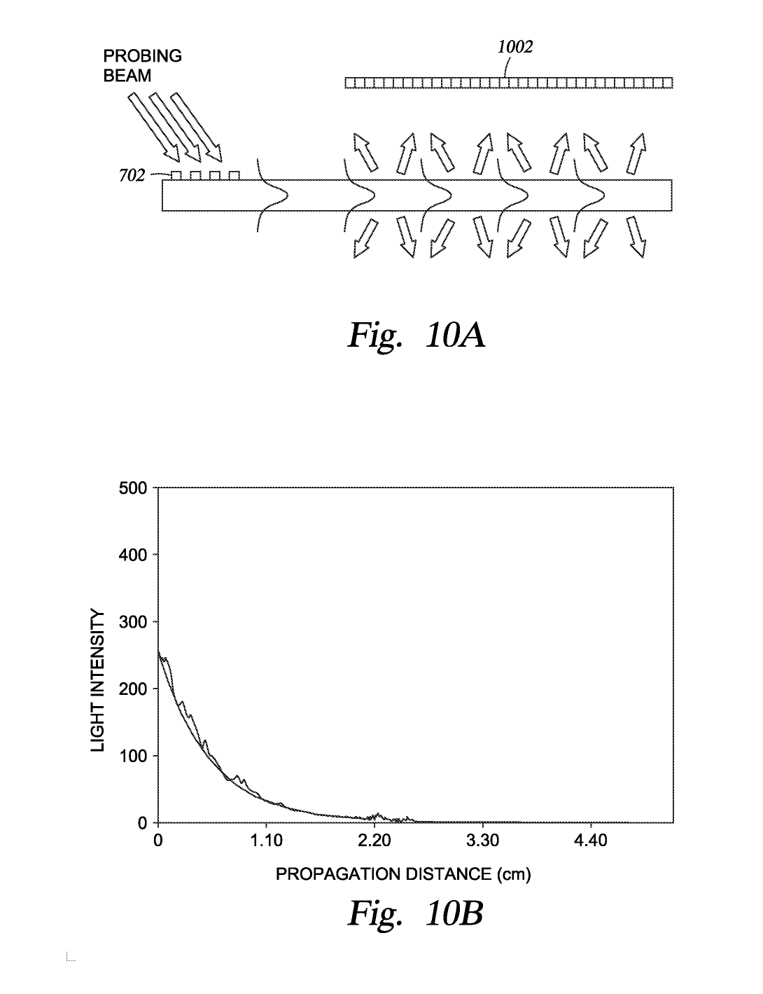

The intensity of light propagated through the linear optical array 300 having N SSCs 130 is given by: I_{N}=I_{N=0}*10^{Nα/10}, and the intensity is exponentially decreasing at a rate described by characteristic optical-propagation constant a (optical loss coefficient), which can be extracted by plotting log₁₀(I_{N}) vs. N and obtaining a linear regression fit through the data points. The method of measuring I_{N} is described in FIG. 10. FIG. 4 is a chart 400 showing a relationship between normalized transmitted intensity and number of SSCs 130 in the linear optical array 300, according to one embodiment of the invention. The white circles represent data from an ideal (defect free) linear optical array of SSCs and the black circles represent data from a linear optical array of SSCs with superimposed sidewall roughness. Beam-propagation method (BPM) is used to simulate light propagating through the two linear optical arrays and to calculate the optical loss coefficient for the two linear optical arrays. Other methods such as finite-difference time-domain (FDTD) or finite-element method (FEM) may be used. The BPM simulations ignore coherent back-reflections, so the periodic array is not operated at frequencies within the stopband. The sidewall roughness represents a realistic form of fabrication-induced disorder which is expected to degrade the device performance by increasing optical losses. For simplicity the roughness is defined here by two parameters: the correlation length L_{c}=100 nanometers and σ=5 nanometers. As shown in chart 400, the disordered case shows deviations from the exponential curve of the ideal case, but the overall trend is clear. To extract the characteristic optical loss for both cases, log₁₀(I_{N}) vs. N are plotted and a linear regression fit through the data points are obtained, as shown in FIG. 5.

FIG. 5 is a chart 500 showing a relationship between log of intensity and number of SSCs 130 in the linear optical array 300, according to one embodiment of the invention. From the linear regression lines, the following optical loss coefficients are obtained. For the ideal case (the white circles), α is equal to −0.416 dB/device. For the disordered case (the black circles), α is equal to −0.544 dB/device. The optical loss coefficient for the ideal case represents the intrinsic optical loss coefficient αᵢₙₜ, which is determined by the taper design which has not been optimized in this case. The artificially superimposed surface roughness adds additional extrinsic optical loss of αₑₓₜ=−0.128 dB/device. The method described above is a practical way of characterizing losses in actual HAMR light delivery systems by studying linear arrays of SSCs and extracting the characteristic loss parameter of a single device. In addition, the measurements can be performed on arrays at various stages of the fabrication process, providing a valuable optical metrology tool for intermediate evaluation of SSC performance.

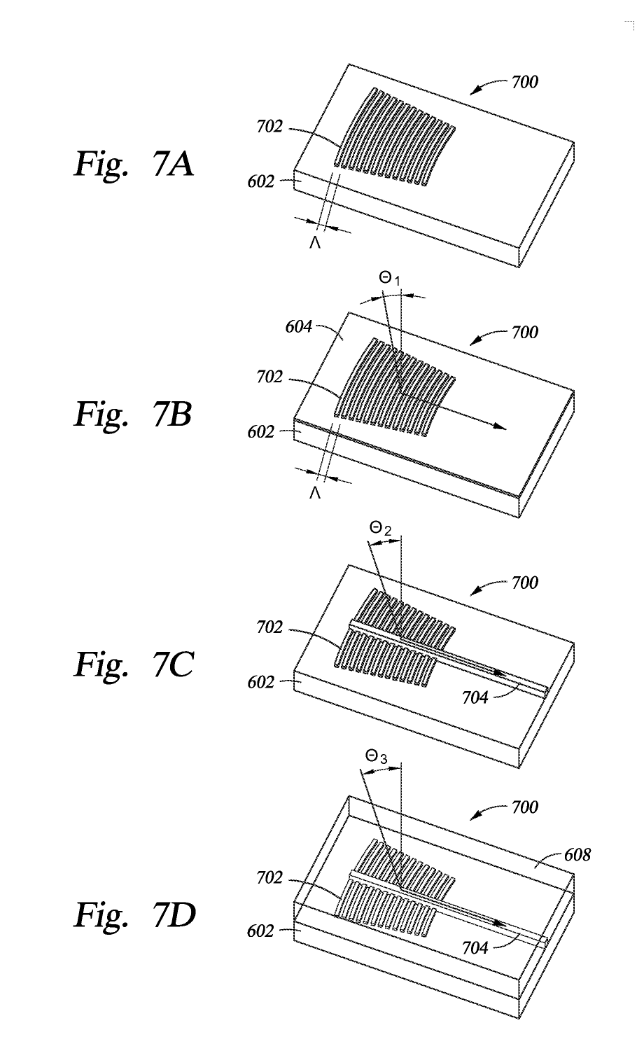

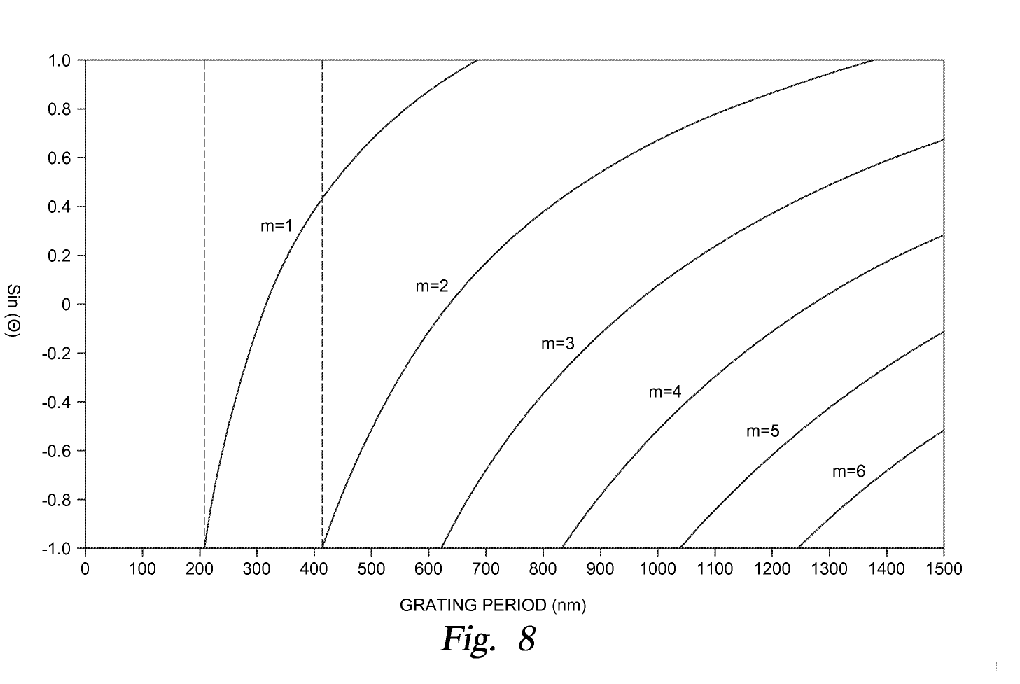

FIGS. 6A-6D illustrate the process of depositing a single SSC 130 in an actual HAMR light delivery system and FIGS. 7A-7D illustrate the process of depositing an optical metrology system 700 at each corresponding stage of the single SSC 130 deposition. Fabrication of the SSC 130 starts at stage (0), as shown in FIG. 6A, with the deposition of bottom cladding 602 having low refractive index (n_{b}) to create index guiding in the wafer plane. For the optical metrology system 700, gratings 702 are deposited over the bottom cladding material 602 at a different location on the wafer. The gratings 702 has grating period “Λ”, and the grating parameters duty cycle and height can be optimized for the particular material system using FDTD simulations. The gratings 702 may be a metal or other suitable material, as long as the material can couple enough light into the guiding layer to produce measurable out-of-plane scattering. At stage (0), optical loss cannot be measured because the guiding layer has not yet been defined.

Next, at stage (1), as shown in FIG. 6B, a higher-index (n_{c}) guiding layer 604 is deposited over the bottom cladding 602. At the same time, as shown in FIG. 7B, the guiding layer 604 is deposited over the bottom cladding 602 and the gratings 702. At this point, since the guiding layer 604 has been deposited, absorption and scattering losses of the guiding layer 604 and the bottom cladding 602 can be characterized.

Next, at stage (2), as shown in FIG. 6C, portions of the guiding layer 604 are removed to form the core 606 of the SSC 130. The core 606 may be the core 202 described in FIG. 2. At the same time, as shown in FIG. 7C, the guiding layer 604 deposited over the gratings 702 is also etched and patterned to form a waveguide 704. The waveguide 704 may include a plurality of cores 202 of the SSC 130. The cores 202 may be arranged as shown in FIG. 3. At stage (2), scattering losses introduced by the lithography and etch that define the core 606 can be quantified.

Finally, at stage (3), as shown in FIG. 6D, side and top cladding 608 are deposited over the bottom cladding 602 and the core 606. At the same time, as shown in FIG. 7D, the top cladding 608 is deposited over the bottom cladding 602, the gratings 702, and the waveguide 704. The top cladding 608 has a refractive index (nₜ) that is lower than both the n_{b} and n_{c}. FIG. 6D illustrates a SSC 130 used for focusing and delivery light in a HAMR device. FIG. 7D illustrates an optical metrology system 700 that is used to measure the performance of the SSC 130. The optical metrology system 700 has gratings 702 and the linear optical array 300. The linear optical array 300 has the bottom cladding 602, the waveguide 704 disposed over the bottom cladding 602 and the top cladding 608 disposed over the bottom cladding 602 and the waveguide 704. Having the optical metrology system 700 enables measuring the performance of the SSC 130 on the wafer level at different stages of the forming of the SSC 130. Light from an external excitation source is coupled into the guiding layer 604 or the waveguide 704 at stages (1)-(3) by adjusting the angle of incidence (θ). The associated change in the coupling efficiency is irrelevant because the method for extracting the loss parameter does not depend on the absolute intensity of the in-coupled light.

The gratings 702 may have a grating period “Λ” that can be obtained by solving the grating equation: n_{eff}=nₜ sin θ+m*(λ/Λ), where n_{eff} is the effective index of the guided mode at the particular fabrication stage, nₜ is the refractive index of the top cladding 608, m is the diffraction order, λ is the free space wavelength of the coupled light, Λ is the grating period and θ is the angle of incidence. The magnitudes of all the relevant parameters should be as large as possible to facilitate fabrication, but not as large as to allow multiple solutions of the grating equation because this would result in coupling into higher diffraction orders, thereby reducing the coupling efficiency.

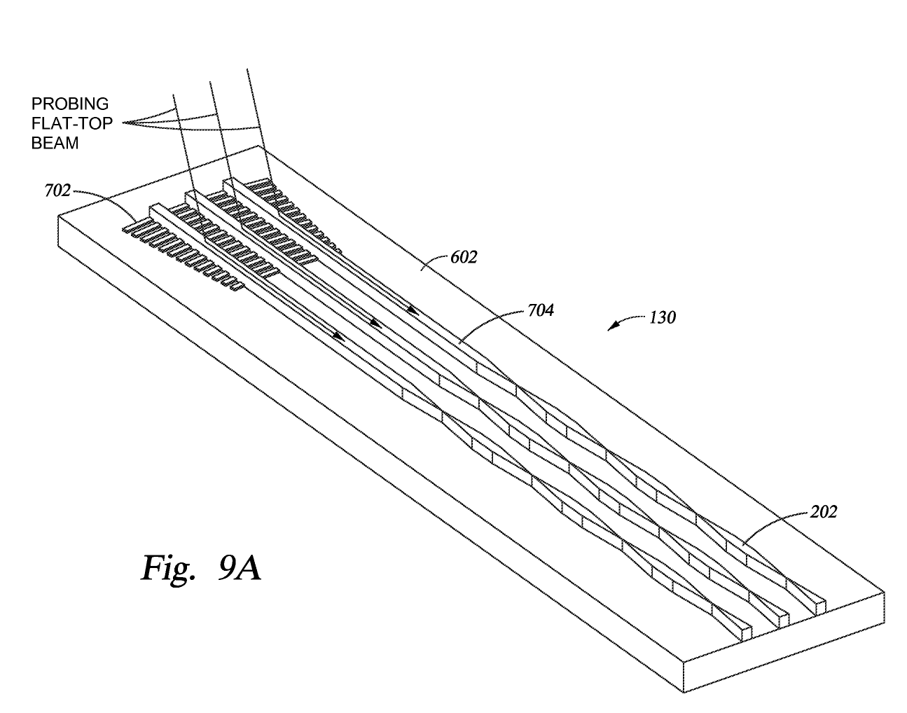

In one embodiment, an optical metrology system 700 has n_{b} of 1.5, n_{c} of 2.0, and nₜ of 1.0. As determined by FDTD simulations, the effective refractive index n_{eff} of the transverse electric (TE) fundamental guided mode in this structure at λ=633 nm is 1.866. The solutions to the grating equation are plotted in FIG. 8. As shown in FIG. 8, the grating period for this embodiment is between 215 nm and 445 nm. The calculation may be repeated for every step where the optical loss coefficient is evaluated (stages (1)-(3) described above) to find the allowed range and the optimal value of Λ.

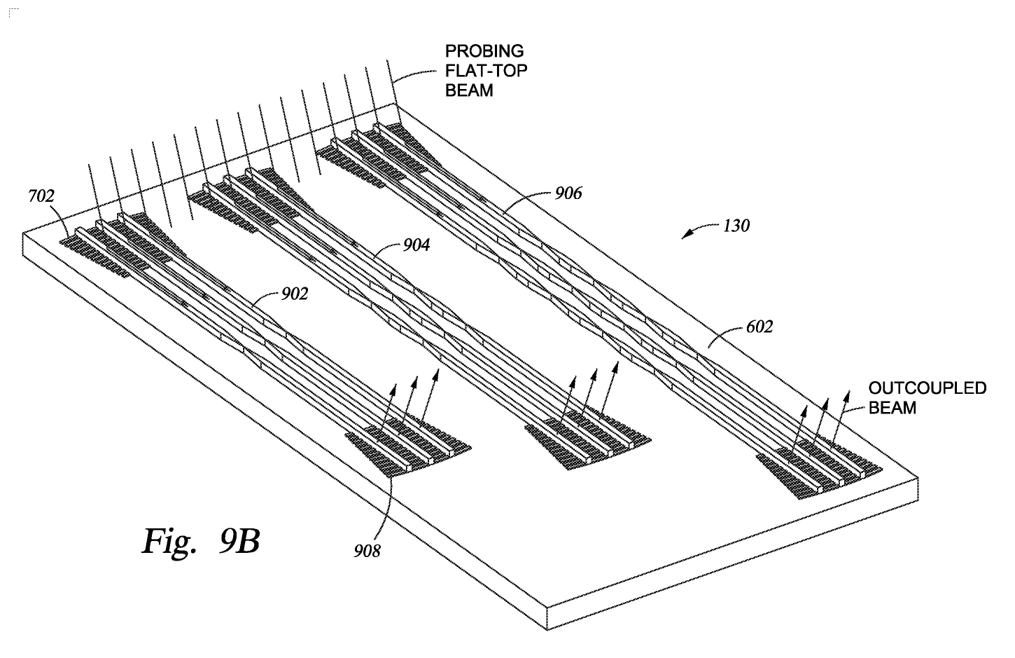

There is a significant modal mismatch between a typical free-space laser beam (a highly collimated with a beam diameter of about 1 mm) or the optical fiber output used as a probing light source and the fundamental guided mode in the waveguide with sub-micron modal diameter. To alleviate this problem, parallel waveguide arrays (cores) can be patterned at stage (2) instead of a single array of cores. This arrangement not only utilizes the probing beam more efficiently, but also provides a natural way of obtaining the average loss per waveguide by probing multiple waveguides simultaneously with a single measurement. The waveguides should be placed sufficiently far apart so that the evanescent waves of the guided modes do not overlap to create coupled-modes. If the waveguides are too close to each other, the effective refractive index of the guided mode will be different and the characteristic loss of the array will not represent the loss of a single isolated SSC 130. The minimum required separation is straightforward to determine with simulations. FIG. 9A shows such multiple waveguides design. As shown in FIG. 9A, a plurality of waveguides 704 is disposed over the bottom cladding 602 and the gratings 702, and each waveguide 704 has a plurality of cores 202. The cores 202 are arranged the same way as shown in FIG. 3.

If the quality of the waveguide layer and the quality of the SSC are high, there may not be sufficient amount of light scattered out of the wafer plane to report on the propagation loss. This could happen for example at stage (3) of the fabrication process when the SSC 130 is buried in the cladding materials and the cladding/air interface is created. In this case, a wafer-level equivalent of the cutback method to determine the propagation loss can be realized by patterning multiple waveguide arrays of various lengths side by side, as shown in FIG. 9B. A redundancy can be created in the number of waveguides of a particular length to facilitate averaging. For illustration purposes there is a three-fold redundancy in FIG. 9B (waveguides 902, 904 and 906), but in practical this number can be in the thousands. The in-coupling gratings 702 are lined up so that a single extended beam can couple the same amount of light into every waveguide in the coupling plane. Such a one-dimensional beam shown schematically as a line of arrows in FIG. 9B can be created from an approximately Gaussian output profile of a free-space laser or an optical fiber with a cylindrical lens or, preferably, with a diffractive optical component that creates a flat-top line profile. The beam dimensions can be as small as the diffraction limit in the longitudinal direction along the waveguides and arbitrarily large in the transverse direction. The flat-top beams are ideally suited for efficient excitation of parallel arrays of waveguides.

Once coupled into the arrays, the light is delivered as the fundamental guided mode of the waveguide towards the longitudinal arrays of SSCs 130. The light transmitted through the arrays of various lengths can be then coupled out of the wafer plane towards a detector, such as a charge-coupled device (CCD) array or a scanning probe) with another set of gratings 908. In one embodiment, as shown in FIG. 9B, there are 2 SSCs 130 in the waveguide 902, 4 SSCs 130 in the waveguide 904 and 6 SSCs 130 in the waveguide 906. The optical metrology system will have significant wider range of lengths. As described above, the characteristic average loss constant a per device can be obtained by plotting log₁₀(I_{N}) vs. N.

The intensity of light in the guiding layer as a function of propagation distance can be determined by measuring the intensity of the vertically scattered light using a scanning probe or a linear CCD array as shown schematically in FIG. 10A. This technique assumes the intensity of the vertically scattered light is proportional to the intensity in the waveguiding component, which is a safe assumption if the structural imperfections are small (<<λ) and are distributed uniformly at length-scales compared to the size of the metrology component. As shown in FIG. 10A, incident problem light is coupled to the wafer plane by the gratins 702. The short arrows pointing away from the wafer plane represent the scattered light, which is measured by a detector 1002. The detector 1002 may be a scanning probe or a linear CCD array. FIG. 10B shows a typical result for a straight ridge waveguide (stage (2) of the fabrication) with the measured loss parameter (α=−8.21 dB/cm).

In summary, a method for measuring the performance of SSCs of HAMR devices on the wafer level is disclosed. An optical metrology system is deposited on a wafer and is used to determine the optical loss coefficient of spot-size converters by measuring the optical loss coefficient of the linear optical array of the optical metrology system. The method does not depend on the intensity of the in-coupled light and may be implemented at various stages of HAMR fabrication.

While the foregoing is directed to embodiments of the present invention, other and further embodiments of the invention may be devised without departing from the basic scope thereof, and the scope thereof is determined by the claims that follow.

What is claimed is:

1. A method for evaluating performance of optical components of a heat assisted magnetic recording device, comprising:
depositing an optical metrology system on a wafer, wherein the optical metrology system includes:
a grating; and
a linear optical array, wherein the linear optical array has:
a bottom cladding;
a waveguide disposed over the bottom cladding; and
a top cladding disposed over the bottom cladding and the waveguide;
coupling a probing light using the grating into the linear optical array;
measuring an optical output from the linear optical array; and
determining an optical loss parameter.

2. The method of claim 1, wherein the optical components and the optical metrology system are formed on a wafer and at the same time.

3. The method of claim 2, wherein the linear optical array includes a plurality of spot-size converters.

4. The method of claim 3, wherein each of the plurality of spot-size converters has a core, and the core has a first end and a second end.

5. The method of claim 4, wherein the first end is straight and the second end is tapered.

6. The method of claim 5, wherein the probing light enters the plurality of spot-size converters through the first end.

7. The method of claim 6, wherein the optical loss parameter is determined by plotting log₁₀(I_{N}) vs. N, wherein I is an intensity of light propagated through the linear optical array and N is a number of the spot-size converters in the linear optical array.

8. The method of claim 7, wherein the intensity of light propagated through the linear optical array is measured by a scanning probe or a charge-coupled device array.

9. The method of claim 1, wherein the optical metrology system includes additional linear optical arrays.

10. An optical metrology system, comprising:
a first grating disposed at a first end of the optical metrology system; and
a linear optical array, wherein the linear optical array includes:
a bottom cladding;
a waveguide disposed over the bottom cladding; and
a top cladding disposed over the bottom cladding and the waveguide.

11. The optical metrology system of claim 10, wherein the linear optical array includes a plurality of spot-size converters.

12. The optical metrology system of claim 11, wherein each spot-size converter of the plurality of spot-size converters has a core, the core has a first end and a second end, and the first end of the core of one spot-size converter is connected to the first end of the core of a first adjacent spot-size converter and the second end of the core of the spot-size converter is connected to the second end of the core of a second adjacent spot-size converter.

13. The optical metrology system of claim 12, wherein the first end is straight and the second end is tapered.

14. The optical metrology system of claim 13, wherein the first end is configured to receive a confined beam and the second end is configured to receive a highly-divergent beam.

15. The optical metrology system of claim 10, further comprising additional linear optical arrays.

16. The optical metrology system of claim 15, wherein each linear optical array includes a plurality of spot-size converters.

17. The optical metrology system of claim 16, wherein each linear optical array has a different number of spot-size converters.

18. The optical metrology system of claim 17, further comprising a second grating disposed at a second end of the optical metrology system opposite the first end of the optical metrology system.

19. The optical metrology system of claim 10, wherein the bottom cladding has a first refractive index, the waveguide has a second refractive index and the top cladding has a third refractive index.

20. The optical metrology system of claim 19, wherein the second refractive index is greater than the first refractive index and the third refractive index.
